(19) United States
(12) Patent Application Publication
(10) Pub. No.: US 2013/0332598 A1
(43) Pub. Date: Dec. 12, 2013

(54) INTERNET PROTOCOL ADDRESS IPv4/IPv6 BASED PACKET FILTERING IN WoWLAN MODE

(71) Applicant: APPLE INC., Cupertino, CA (US)

(72) Inventors: Veerendra Boodannavar, Sunnyvale, CA (US); Kapil Chhabra, Milpitas, CA (US)

(21) Appl. No.: 13/627,961

(22) Filed: Sep. 26, 2012

Related U.S. Application Data
(60) Provisional application No. 61/657,825, filed on Jun. 10, 2012.

(51) Int. Cl. H04L 12/26

(52) U.S. Cl. CPC H04L 43/04
USPC 709/224

(57) ABSTRACT

One embodiment of the present invention provides a system configured to apply Internet Protocol (IP) address based packet filtering prior to entering Wake on Wireless LAN (WoWLAN) mode. During operation, the system receives a request to enter WoWLAN mode. In response to this request, the system collects a set of active IP addresses, as well as a set of active ports. Next, the system filters out packets destined to IP addresses that are not members of the set of active IP addresses, and ports that are not members of the set of active ports. Finally, the system enters WoWLAN mode.

### RELATED APPLICATION

This application hereby claims priority under 35 U.S.C. §119 to U.S. Provisional Patent Application No. 61/657,825, filed on 10 Jun. 2012, entitled “INTERNET PROTOCOL ADDRESS IPv4/IPv6 BASED PACKET FILTERING,” by inventors Veerendra Boodannavar and Kapil Chhabra, having attorney docket number APL-P15574USP1.

### BACKGROUND

1. Field of the Invention

The present invention relates to network devices. More specifically, the present invention relates to a method and an apparatus for facilitating Internet Protocol address IPv4/IPv6 based packet filtering in Wake on Wireless LAN (WoWLAN) mode.

### RELATED ART

Mobile devices, such as smartphones, tablets, and PDAs, typically have limited power resources, and are typically configured to optimize power savings. One of the ways in which these devices achieve significant power savings is in shutting down services that are not currently being utilized. For example, in many devices, wireless networking accounts for a significant portion of the power consumption. Thus, at times when the network is not being utilized, it is beneficial to shut down the wireless network, or to enter a low-power mode. However, shutting down services can result in other significant drawbacks. For example, if the wireless network is shut down, then the device will not be aware of incoming requests via the wireless network.

In order to alleviate the problem of excessive power consumption by idle wireless networks, many devices employ a feature called Wake on Wireless LAN (WoWLAN). WoWLAN allows a device to shut down most of its wireless services, while listening for specific packets that will wake the device from WoWLAN mode. In this manner, the device can enter a power-saving state until it receives a packet that returns it to a normal operating mode. While this technique results in increased power savings over devices without WoWLAN capabilities, WoWLAN-enabled devices are regularly brought out of WoWLAN mode by errant packets and garbage traffic. For example, a multicast message broadcast by a new device to the wireless network can cause other devices to wake from WoWLAN mode, even if the multicast message is of no concern to the device.

### SUMMARY

One embodiment of the present invention provides a system configured to apply Internet Protocol (IP) address based packet filtering prior to entering Wake on Wireless LAN (WoWLAN) mode. During operation, the system receives a request to enter WoWLAN mode. In response to this request, the system collects a set of active IP addresses, as well as a set of active ports. Next, the system filters out packets destined to IP addresses that are not members of the set of active IP addresses, and ports that are not members of the set of active ports. Finally, the system enters WoWLAN mode.

In some embodiments of the present invention, the system additionally collects a designation of a protocol. The system then filters out packets that are not transmitted via the designated protocol.

In some embodiments of the present invention, the protocol can include User Datagram Protocol (UDP) or Transmission Control Protocol (TCP).

In some embodiments of the present invention, the system applies unicast filters before applying port-based filters.

In some embodiments of the present invention, the system applies multicast filters before applying port-based filters.

In some embodiments of the present invention, the system disconnects from an access point and leaves the basic service set if the set of active IP addresses and the set of active ports are empty sets.

In some embodiments of the present invention, the set of active IP addresses can include IPv4 addresses and IPv6 addresses.

### BRIEF DESCRIPTION OF THE FIGURES

FIG. 1 illustrates a computing environment in accordance with an embodiment of the present invention.

FIG. 2 illustrates a handset in accordance with an embodiment of the present invention.

FIG. 3 presents a flow chart illustrating the process of performing IP address based packet filtering in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed. Note that the term “non-transitory computer-readable storage medium” comprises all computer-readable media, with the sole exception of a propagating electromagnetic signal.

The methods and processes described in the detailed description section can be embodied as code and/or data, which can be stored on a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

One embodiment of the present invention provides a system configured to apply Internet Protocol (IP) address based packet filtering prior to entering Wake on Wireless LAN (WoWLAN) mode. During operation, the system receives a request to enter WoWLAN mode. In response to this request, the system collects a set of active IP addresses, as well as a set of active ports. Note that, in some embodiments, the system may continually maintain the list of actively configured IP addresses and ports so that a request to enter WoWLAN mode is not delayed by a collection and/or configuration operation.

Note that, while the Instant Application discusses WoWLAN mode, any other form of network power savings that allows outside traffic to return the device to normal operating mode may be used with embodiments of the present invention.

Next, the system filters out packets destined to IP addresses that are not members of the set of active IP addresses, and ports that are not members of the set of active ports. Thus, only packets destined for actively configured IP addresses and ports on the current host will wake the host from WoWLAN mode. Finally, the system enters WoWLAN mode.

In some embodiments of the present invention, the system additionally collects a designation of a protocol. The system then filters out packets that are not transmitted via the designated protocol. For example, the protocol can include User Datagram Protocol (UDP) or Transmission Control Protocol (TCP). Thus, if port 113, for example, is only configured for TCP, an inbound packet destined for port 113 via UDP would not cause the device to wake from WoWLAN mode.

In some embodiments of the present invention, the system applies unicast filters before applying port-based filters, while in some embodiments of the present invention, the system applies multicast filters before applying port-based filters. This method of applying multiple levels of filtering prevents unsolicited unicast and multicast packets from passing through and waking up the host. This can prevent frequent device wakeups due to unwanted packets, which saves significant battery power.

In some embodiments of the present invention, the system disconnects from an access point and leaves the basic service set if the set of active IP addresses and the set of active ports are empty sets. If the host has no configured IP addresses and no active ports, then the device can safely ignore all wireless traffic on the particular wireless interface. In this instance, the device can decouple from the wireless access point, and leave the basic service set. Additionally, the device may completely power-down the wireless radio and optionally enter an additional power-saving mode.

In some embodiments of the present invention, the set of active IP addresses can include IPv4 addresses and IPv6 addresses. Note that, while IP addresses (including IPv4 and IPv6), ports, and protocols are discussed in the Instant Application, any other means of routing and transmitting packets, now known or later developed, may be used with embodiments of the present invention. What is important is that only packets destined for specific services on the host will wake the host from WoWLAN mode. Any other packets, including unsolicited packets destined for the device, are simply ignored and not allowed to wake the host from WoWLAN mode.

### Computing Environment

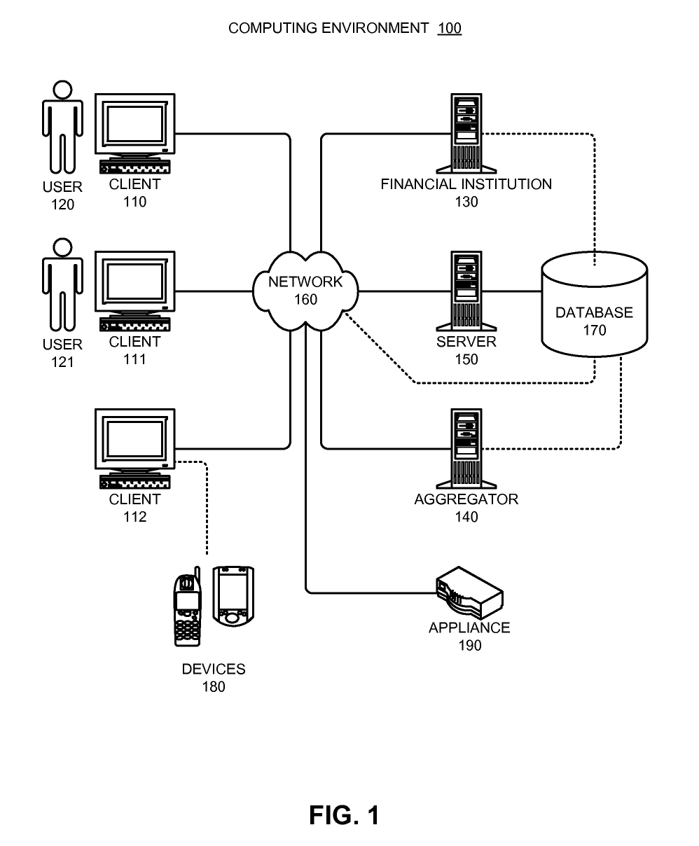

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, financial institution 130, aggregator 140, server 150, network 160, database 170, devices 180, and appliance 190.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Similarly, server 150 can generally include any node on a network including a mechanism for servicing requests from a client for computational and/or data storage resources. Server 150 can participate in an advanced computing cluster, or can act as a stand-alone server.

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled: to a server (such as server 150), to a client, or directly to a network.

Devices 180 can include any type of electronic device that can be coupled to a client, such as client 112. This includes, but is not limited to, cell phones, personal digital assistants (PDAs), tablets, smartphones, personal music players (such as MP3 players), gaming systems, digital cameras, video cameras, portable storage media, or any other device that can be coupled to the client. Note that, in some embodiments of the present invention, devices 180 can be coupled directly to network 160 and can function in the same manner as clients 110-112.

Appliance 190 can include any type of appliance that can be coupled to network 160. This includes, but is not limited to, routers, switches, load balancers, network accelerators, and specialty processors. Appliance 190 may act as a gateway, a proxy, or a translator between server 140 and network 160.

Note that different embodiments of the present invention may use different system configurations, and are not limited to the system configuration illustrated in computing environment 100. In general, any device that is capable of communicating via network 160 may incorporate elements of the present invention.

### Handset

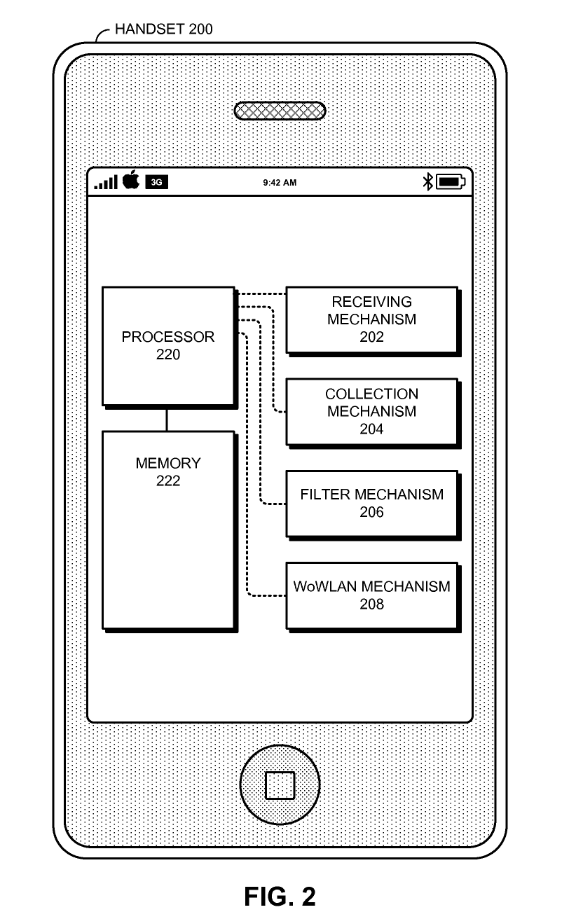

FIG. 2 illustrates a handset 200 (or more generally a “computing device) in accordance with an embodiment of the present invention. As illustrated in FIG. 2, handset 200 can include receiving mechanism 202, collection mechanism 204, filter mechanism 206, WoWLAN mechanism 208, processor 220, and memory 222.

Additionally, handset 200 can include any type of electronic device that can be coupled to a client, such as client 112. This includes, but is not limited to, cell phones, personal digital assistants (PDAs), tablets, smartphones, personal music players (such as MP3 players), gaming systems, digital cameras, video cameras, portable storage media, or any other device that can be coupled to the client.

### IP Address Based Packet Filtering

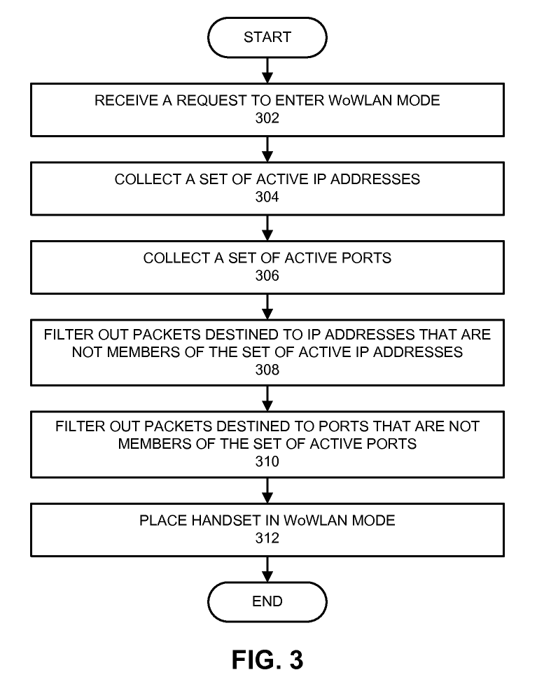

FIG. 3 presents a flow chart illustrating the process of performing IP address based packet filtering in accordance with an embodiment of the present invention.

During operation, receiving mechanism 202 receives a request to enter WoWLAN mode (operation 302). In response to the request, collection mechanism 204 collects a set of active IP addresses (operation 304). In addition, collection mechanism 204 also collects a set of active ports (operation 306). Note that, as described previously, collection mechanism 204 may maintain a list of active IP addresses and active ports in real-time, or near real-time, instead of waiting for a WoWLAN request.

Next, filter mechanism 206 filters out packets destined to IP addresses that are not members of the set of active IP addresses (operation 308). Additionally, filter mechanism 206 filters out packets destined to ports that are not members of the set of active ports (operation 310). Optionally, as described previously, in some embodiments, filter mechanism 206 additionally filters out packets based on specific protocols. Finally, WoWLAN mechanism 208 places handset 200 in WoWLAN mode (operation 312).

Note that in some embodiments, if there are no actively configured IP addresses or ports on handset 200, WoWLAN mechanism 208 may additionally decouple handset 200 from a wireless access point and leave the basic service set. Additionally, handset 200 may then enter a more-robust power-saving mode.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computing device configured to apply Internet Protocol (IP) address based packet filtering prior to entering Wake on Wireless LAN (WoWLAN) mode, comprising:
a memory;
a processor;
a receiving mechanism configured to receive a request to enter WoWLAN mode;
a collection mechanism configured to collect a set of active IP addresses;
wherein the collection mechanism is further configured to collect a set of active ports;
a filter mechanism configured to filter out a packet destined to an IP address that is not a member of the set of active IP addresses;
wherein the filter mechanism is further configured to filter out a packet destined to a port that is not a member of the set of active ports; and
a WoWLAN mechanism configured to place the computing device in WoWLAN mode.

2. The computing device of claim 1:
wherein the collection mechanism is further configured to collect a designation of a protocol; and
wherein the filter mechanism is further configured to filter out a packet that is not transmitted via the designated protocol.

3. The computing device of claim 2, wherein the protocol can include at least one of:
User Datagram Protocol (UDP); and
Transmission Control Protocol (TCP).

4. The computing device of claim 1, wherein the filter mechanism applies unicast filters before applying port-based filters.

5. The computing device of claim 1, wherein the filter mechanism applies multicast filters before applying port-based filters.

6. The computing device of claim 1, wherein the WoWLAN mechanism is further configured to disconnect from an access point and leave the basic service set if the set of active IP addresses and the set of active ports are empty sets.

7. The computing device of claim 1, wherein the set of active IP addresses can include IPv4 addresses and IPv6 addresses.

8. A computer-implemented method for applying Internet Protocol (IP) address based packet filtering prior to entering Wake on Wireless LAN (WoWLAN) mode, the method comprising:
receiving, by computer, a request to enter WoWLAN mode;
collecting, by computer, a set of active IP addresses;
collecting, by computer, a set of active ports;
filtering out, by computer, a packet destined to an IP address that is not a member of the set of active IP addresses;
filtering out, by computer, a packet destined to a port that is not a member of the set of active ports; and
entering, by computer, into WoWLAN mode.

9. The computer-implemented method of claim 8, further comprising:
collecting a designation of a protocol; and
filtering out a packet that is not transmitted via the designated protocol.

10. The computer-implemented method of claim 9, wherein the protocol can include at least one of:
User Datagram Protocol (UDP); and
Transmission Control Protocol (TCP).

11. The computer-implemented method of claim 8, further comprising applying unicast filters before applying port-based filters.

12. The computer-implemented method of claim 8, further comprising applying multicast filters before applying port-based filters.

13. The computer-implemented method of claim 8, further comprising disconnecting from an access point and leaving the basic service set if the set of active IP addresses and the set of active ports are empty sets.

14. The computer-implemented method of claim 8, wherein the set of active IP addresses can include IPv4 addresses and IPv6 addresses.

15. A non-transitory computer-readable storage medium storing instructions that when executed by a computer cause the computer to perform a method for applying Internet Protocol (IP) address based packet filtering prior to entering Wake on Wireless LAN (WoWLAN) mode, the method comprising:
receiving, by computer, a request to enter WoWLAN mode;
collecting, by computer, a set of active IP addresses;
collecting, by computer, a set of active ports;
filtering out, by computer, a packet destined to an IP address that is not a member of the set of active IP addresses;
filtering out, by computer, a packet destined to a port that is not a member of the set of active ports; and
entering, by computer, into WoWLAN mode.

16. The non-transitory computer-readable storage medium of claim 15, wherein the method further comprises:
collecting a designation of a protocol; and
filtering out a packet that is not transmitted via the designated protocol.

17. The non-transitory computer-readable storage medium of claim 16, wherein the protocol can include at least one of:
User Datagram Protocol (UDP); and
Transmission Control Protocol (TCP).

18. The non-transitory computer-readable storage medium of claim 15, wherein the method further comprises applying unicast filters before applying port-based filters.

19. The non-transitory computer-readable storage medium of claim 15, wherein the method further comprises applying multicast filters before applying port-based filters.

20. The non-transitory computer-readable storage medium of claim 15, wherein the method further comprises disconnecting from an access point and leaving the basic service set if the set of active IP addresses and the set of active ports are empty sets.

21. The non-transitory computer-readable storage medium of claim 15, wherein the set of active IP addresses can include IPv4 addresses and IPv6 addresses.
